(19) United States
(12) Patent Application Publication
(10) Pub. No.: US 2026/0351040 A1
(43) Pub. Date: Nov. 5, 2026

(54) METHOD FOR DETECTING SPEAKING BEHAVIOR, ROBOT CONTROL DEVICE AND COMPUTER-READABLE STORAGE MEDIUM

(71) Applicant: UBTECH ROBOTICS CORP LTD, Shenzhen (CN)

(72) Inventor: YUSHENG ZENG, Shenzhen (CN)

(21) Appl. No.: 19/287,842

(22) Filed: Aug. 1, 2025

(30) Foreign Application Priority Data
Sep. 14, 2024 (CN) 202411297115.1

(51) Int. Cl. G06V 40/16; B25J 11/00; G06V 10/774; G06V 40/20

(52) U.S. Cl. CPC G06V 40/165; B25J 11/0005; G06V 10/774; G06V 40/171; G06V 40/20; G06V 2201/07

(57) ABSTRACT

A method for detecting speaking behavior includes: acquiring a target facial image of a target person at a current moment and calculating an actual lip distance of the target person in the target facial image; determining whether an actual speaking trend state of the target person at the current moment is a suspected speaking state according to the actual lip distance and multiple historical lip distances in multiple historical facial images of the target person at multiple consecutive historical moments prior to the current moment; in response to the actual speaking trend state being the suspected speaking state, performing state statistics on the actual speaking trend state and multiple historical speaking trend states of the target person at the multiple consecutive historical moments to obtain a real-time state distribution ratio of the suspected speaking state at the current moment; and determining whether the real-time state distribution ratio exceeds a threshold.

### CROSS REFERENCE TO RELATED APPLICATIONS

This application claims priority to Chinese Patent Application No. CN 202411297115.1, filed Sep. 14, 2024, which is hereby incorporated by reference herein as if set forth in its entirety.

### TECHNICAL FIELD

The present disclosure generally relates to computer vision technologies, and in particular, relates to a method for detecting speaking behavior, a robot control device and a computer-readable storage medium.

### BACKGROUND

With the continuous advancement of technology, computer vision technology has been increasingly applied in fields such as video surveillance and public security. Among these applications, the human-computer interaction (HCI) design of intelligent robots has become an important research focus in computer vision. In the HCI process of intelligent robots, it is often necessary to detect and determine a user's speaking behavior using computer vision technology. This enables timely confirmation of whether the user has finished speaking, so that the recently spoken audio can be captured and processed by a large language model to generate a response, or to promptly determine whether the user is attempting to activate the robot. Therefore, how to effectively improve the accuracy of detecting user speaking behavior and avoid missed or false detections has become a critical issue that needs to be addressed in current computer vision research for intelligent robots.

### BRIEF DESCRIPTION OF DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is a schematic block diagram illustrating the components of a robot control device 10 according to one embodiment.

FIG. 2 is an exemplary flowchart of a method for detecting speaking behavior according to one embodiment.

FIG. 3 is an exemplary flowchart illustrating the steps included in Step S210 of FIG. 2.

FIG. 4 is a schematic diagram showing the distribution of keypoints of a face according to one embodiment.

FIG. 5 is an exemplary flowchart of the steps included in step S220 in FIG. 2.

FIG. 6 is an exemplary flowchart of steps included in step S221 in FIG. 5.

FIG. 7 is another exemplary flowchart of steps included in step S221 in FIG. 5.

FIG. 8 is an exemplary flowchart of the method for detecting speaking behavior according to another embodiment.

FIG. 9 is an exemplary flowchart illustrating the steps included in Step S270 of FIG. 8.

FIG. 10 is an exemplary flowchart of the method for detecting speaking behavior according to another embodiment.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one” embodiment.

Although the features and elements of the present disclosure are described as embodiments in particular combinations, each feature or element can be used alone or in other various combinations within the principles of the present disclosure to the full extent indicated by the broad general meaning of the terms in which the appended claims are expressed.

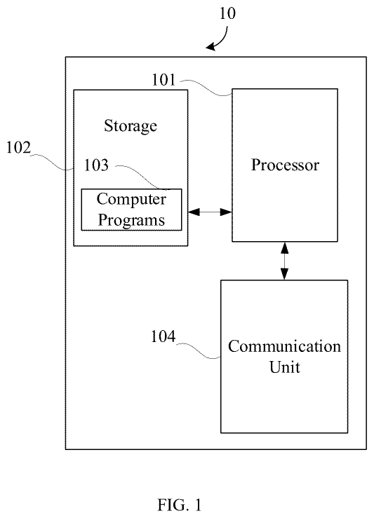

FIG. 1 is a schematic block diagram illustrating the components of a robot control device 10 according to one embodiment. In one embodiment, the robot control device 10 can be communicatively connected to an intelligent robot and configured to acquire facial images of the interacting person captured in real time by the intelligent robot. This allows the robot control device to effectively and stably characterize the interacting person's speaking behavior changes over a period of time through changes in lip distance across consecutive facial image frames, and determine the changes in speaking trend states of the interacting person during the human-robot interaction process. Based on the identified changes in speaking trend states, a voting mechanism is employed to conduct high-precision detection of the actual speaking behavior of the interacting person during human-computer interaction. This ensures that the final output of speaking behavior detection results meets high-accuracy requirements and effectively reflects the true speaking status of the interacting person, thereby significantly improving the issues of missed or false detection of user speaking behavior. Additionally, this largely eliminates the negative impact (for example, the phenomenon of significant lip distance calculation errors caused by lip keypoint disturbances in a single frame of facial image) of facial image keypoint disturbances on speaking behavior detection operations. The robot control device 10 may be a computing device independent of the intelligent robot. Such a computing device may include, but is not limited to, a personal computer, cloud server, laptop, or tablet. Alternatively, the robot control device 10 may be a physical hardware device integrated with the intelligent robot.

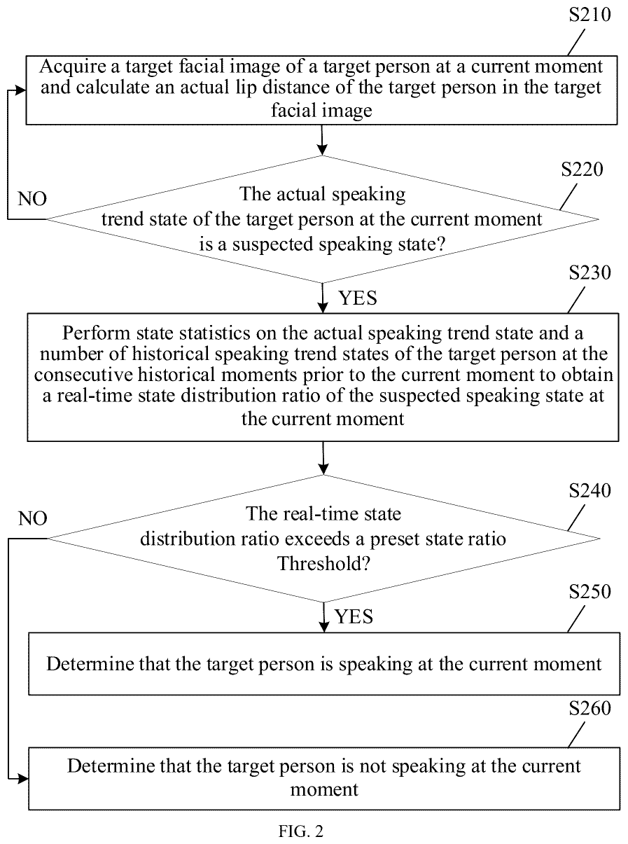

In one embodiment, the electronic device 110 may include a processor 101, a storage 102, and one or more executable computer programs 103 that are stored in the storage 102. The storage 102 and the processor 101 are directly or indirectly electrically connected to each other to realize data transmission or interaction. For example, they can be electrically connected to each other through one or more communication buses or signal lines. The processor 101 performs corresponding operations by executing the executable computer programs 103 stored in the storage 102. When the processor 101 executes the computer programs 103, the steps in the embodiments of a method for detecting speaking behavior, such as steps S210 to S260 in FIG. 2 are implemented.

The processor 101 may be an integrated circuit chip with signal processing capability. The processor 101 may be a central processing unit (CPU), a graphics processing unit (GPU), a general-purpose processor, a network processor (NP), a digital signal processor (DSP), an application specific integrated circuit (ASIC), a field-programmable gate array (FPGA), a programmable logic device, a discrete gate, a transistor logic device, or a discrete hardware component. The general-purpose processor may be a microprocessor or any conventional processor or the like. The processor 101 can implement or execute the methods, steps, and logical blocks disclosed in the embodiments of the present disclosure.

The storage 102 may be, but not limited to, a random-access memory (RAM), a read only memory (ROM), a programmable read only memory (PROM), an erasable programmable read-only memory (EPROM), and an electrical erasable programmable read-only memory (EEPROM). The storage 102 may be an internal storage unit of the robot control device, such as a hard disk or a memory. The storage 102 may be an external storage device of the robot control device, such as a plug-in hard disk, a smart memory card (SMC), and a secure digital (SD) card, or any suitable flash cards. Furthermore, the storage 102 may include both an internal storage unit and an external storage device. The storage 102 is to store computer programs, other programs, and data required by the electronic device 110. The storage 102 can be used to temporarily store data that has been output or is about to be output. Upon receiving an execution instruction, the processor 101 can correspondingly execute the computer program stored on the storage 102.

Exemplarily, the one or more computer programs 103 may be divided into one or more modules/units, and the one or more modules/units are stored in the storage 102 and executable by the processor 101. The one or more modules/units may be a series of computer program instruction segments capable of performing specific functions, and the instruction segments are used to describe the execution process of the one or more computer programs 103 in the robot control device.

In one embodiment, the storage 102 may store a pre-trained facial keypoint detection model, which can be used to perform facial keypoint detection on any facial image of the interacting person to determine the corresponding facial keypoint information (including the pixel location information of a preset number—e.g., 68, 98, or 106—of facial keypoints in the respective facial image) in the facial image. This facilitates the extraction of lip-related keypoint information (including the pixel location information of all lip keypoints in the corresponding facial image) from the facial keypoint information for lip distance calculation, thereby obtaining the effective lip distance of the interacting person in the respective facial image.

It should be noted that the block diagram shown in FIG. 1 is only an example of the robot control device. The robot control device may include more or fewer components than what is shown in FIG. 1, or have a different configuration than what is shown in FIG. 1. Each component shown in FIG. 1 may be implemented in hardware, software, or a combination thereof. For example, the robot control device may further include a communication unit 104 that is directly or indirectly electrically connected to the processor 101 to realize data transmission or interaction. For example, they can be electrically connected to each other through one or more communication buses or signal lines. In one embodiment, the communication unit 104 is configured to establish a communication connection between the robot control device 10 and other electronic devices via a network, and to transmit/receive data through the network. The network includes both wired and wireless communication networks. For example, the robot control device 10 can use the communication unit 104 to acquire facial images of the interacting person captured in real-time by the intelligent robot. It can then send the speaking behavior detection results derived from these facial images back to the intelligent robot, enabling the robot to promptly respond to the interacting person.

The robot control device 10 may pre-store one or more specific computer programs related to user speaking behavior detection function in the storage 102. By executing the one or more specific computer programs stored in the storage 102 via the processor 101, based on a combination of detection of changes in lip distance across consecutive facial image frames and a voting mechanism, the negative impact of facial keypoint disturbances on speaking behavior detection can be effectively eliminated and the missed/false detection issues can be reduced, thereby improving detection accuracy. As a result, the final output of speaking behavior detection results meets high-accuracy requirements and reliably reflects the actual speaking status of the interacting person.

In order to ensure that the robot control device 10 can effectively combine detection of changes in lip distance across consecutive facial image frames with a voting mechanism to eliminate the negative impact of facial keypoint disturbances on speaking behavior detection, reduce missed or false detections, and thereby improve the accuracy of speaking behavior detection so that the resulting detection output reliably reflects the actual speaking status of the interacting person, an embodiment of the present disclosure provides a method for detecting speaking behavior to achieve the above objective. The method for detecting speaking behavior will be described in detail below.

FIG. 2 is an exemplary flowchart of a method for detecting speaking behavior according to one embodiment. As an example, but not a limitation, the method can be implemented by the robot control device 10. The method may include steps S210 to S260.

Step S210: Acquire a target facial image of a target person at a current moment and calculate an actual lip distance of the target person in the target facial image.

The target person refers to the interacting person in the human-robot interaction process with the intelligent robot. Whenever the robot control device 10 obtains a facial image of the target person captured in real time by the intelligent robot, that moment may be designated as the current moment, and the facial image captured by the intelligent robot at the current moment is taken as the target facial image. The robot control device then invokes a pre-trained facial keypoint detection model to perform facial keypoint detection on the target facial image. Based on the pixel position information of each detected facial keypoint in the target facial image, the effective lip distance (i.e., the actual lip distance) of the target person in the target facial image is calculated.

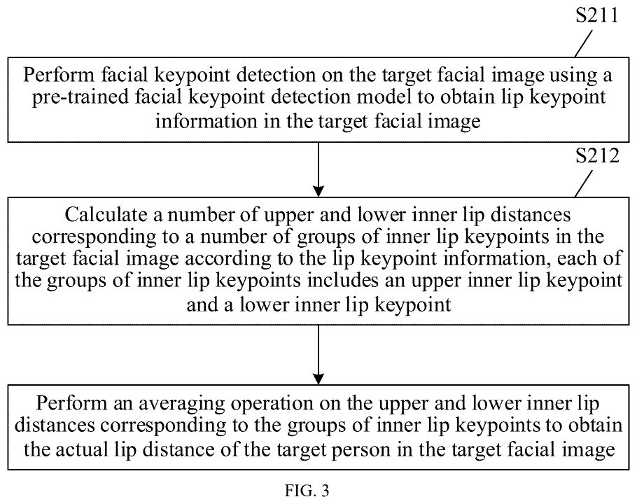

FIG. 3 is an exemplary flowchart illustrating the steps included in Step S210 of FIG. 2. In one embodiment, the step of calculating the actual lip distance of the target person in the target facial image of Step S210 may include steps S211 to S213, so as to calculate the effective lip distance of the target person in the target facial image as accurately as possible.

Step S211: Perform facial keypoint detection on the target facial image using a pre-trained facial keypoint detection model to obtain lip keypoint information in the target facial image.

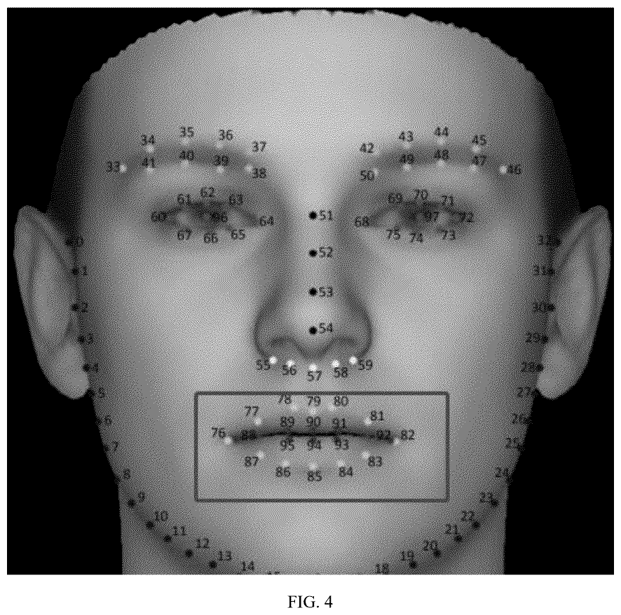

In one embodiment, the facial keypoint detection model may be trained using a facial sample image set annotated with at least 98 facial keypoints (e.g., keypoints 0-97 in FIG. 4). This ensures that when performing facial keypoint detection on any facial image, the facial keypoint detection model is capable of extracting 98 facial keypoints that represent global facial correlation from the facial image. Then, 20 lip keypoints (such as facial keypoints 76-95 in the rectangular box in FIG. 4) related to the lip area are selected from the 98 extracted facial keypoints to obtain the lip keypoint information in the facial image (including the pixel position information of each of the 20 lip keypoints in the corresponding facial image).

Step S212: Calculate a number of upper and lower inner lip distances corresponding to a number of groups of inner lip keypoints in the target facial image according to the lip keypoint information. Each of the groups of inner lip keypoints includes an upper inner lip keypoint and a lower inner lip keypoint.

If the 20 lip keypoints related to the lip area are directly used to calculate the lip distance, it may cause the detected change in lip distance between two adjacent frames of facial images to be inconsistent with the actual situation (for example, interacting person may not exhibit any lip movement, yet the calculated change in lip distance is mistakenly interpreted as a lip movement.) In one embodiment, 6 inner lip keypoints among the 20 lip keypoints, such as lip keypoints 89-91 and 93-95 as shown in FIG. 4 that exhibit the most significant feature changes during lip movement can be used for lip distance calculation. This helps ensure that the final calculated lip distance closely reflects the actual lip movement of the interacting person. Therefore, after obtaining the lip keypoint information in the target facial image, the robot control device 10 can select 3 groups of inner lip keypoints from the lip keypoint information. Here, each group of inner lip keypoints consists of an upper inner lip keypoint (for example, any one of the lip keypoints 89-91 in FIG. 4) and a lower inner lip keypoint (for example, any one of the lip keypoints 93-95 in FIG. 4). Specifically, the lip keypoints 89 and 95 constitute a first group of inner lip keypoints, lip keypoints 90 and 94 constitute a second group of inner lip keypoints, and lip keypoint 91 and 95 constitute a third group of inner lip keypoints. Then, for each group of inner lip keypoints, keypoint distance calculation is performed according to the pixel position information of the upper inner lip keypoint and the lower inner lip keypoint in the group of inner lip keypoints to obtain the upper and lower inner lip distance of the group of inner lip keypoints.

Step S213: Perform an averaging operation on the upper and lower inner lip distances corresponding to the groups of inner lip keypoints to obtain the actual lip distance of the target person in the target facial image.

Accordingly, by executing the above steps S211 to S213, the robot control device can accurately calculate the effective lip distance of the target person in the target facial image as precisely as possible.

Step S220: Determine whether an actual speaking trend state of the target person at the current moment is a suspected speaking state according to the actual lip distance and a number of historical lip distances in a number of historical facial images of the target person at a number of consecutive historical moments prior to the current moment.

Actually, when the interacting person is not speaking, there is basically no change in the lip distance between different facial images. Only when the interacting person is speaking will there be a period of time when the lip distance across frames obviously changes. That is to say, the change in the lip distance between two adjacent frames of facial images or two arbitrarily specified frames of facial images is difficult to reflect the actual speaking trend of the interacting person in the process of his speaking behavior change. If the change in the lip distance between two frames of facial images is directly used to identify the speaking behavior, it is highly likely to result in missed or false detections.

Therefore, after the robot control device 10 calculates the actual lip distance of the target person at the current time, it selects, according to a first preset number (a positive integer greater than 1), the historical lip distances of multiple historical moments that are continuously distributed with the current moment from the historical lip distances of the target person in the historical facial images of many historical moments prior to the current moment. This can effectively and stably characterize the process of the interacting person's speaking behavior changes over a period of time through the lip distance changes between the actual lip distance and the first preset number of historical lip distances, ensuring that the actual speaking trend state of the target person at the current moment can match the actual speaking status of the target person as much as possible, which helps reduce missed or false detections of speaking behavior.

In one embodiment, the robot control device 10 can construct a lip distance queue for the target person in the storage 102, and record the effective lip distance values of the target person at different moments within a period of time in chronological order through the lip distance queue. Therefore, the robot control device 10 can write the actual lip distance of the target person at the current moment into the end of the lip distance queue, and delete the historical lip distance recorded at the head of the lip distance queue. At this time, all the historical lip distances recorded in the lip distance queue except the actual lip distance are the historical lip distances of multiple historical moments that are continuously distributed with the current moment, and the queue length of the lip distance queue is obtained by adding one to the first preset number.

In one embodiment, the speaking trend state of any interacting person at any moment may be a suspected speaking state or a not-yet-speaking state. The suspected speaking state is used to characterize that the corresponding interacting person may be speaking at the corresponding moment, and the not-yet-speaking state is used to characterize that the corresponding interacting person is not speaking at the corresponding moment.

In this case, when the robot control device 10 determines that the actual speaking trend state of the target person at the current moment is not a suspected speaking state (i.e., the actual speaking trend state of the target person at the current moment is a not-yet-speaking state), it can be determined that the target person is considered not to be speaking at the current moment. Then, the robot control device 10 will jump back to the step S210 so as to perform speaking behavior detection on the facial image of the target person at the next moment (i.e., the new current moment) following the current moment. When the robot control device 10 determines that the actual speaking trend state of the target person at the current moment is a suspected speaking state, the robot control device 10 will correspondingly execute step S230 to further confirm whether the target person is actually speaking at the current moment.

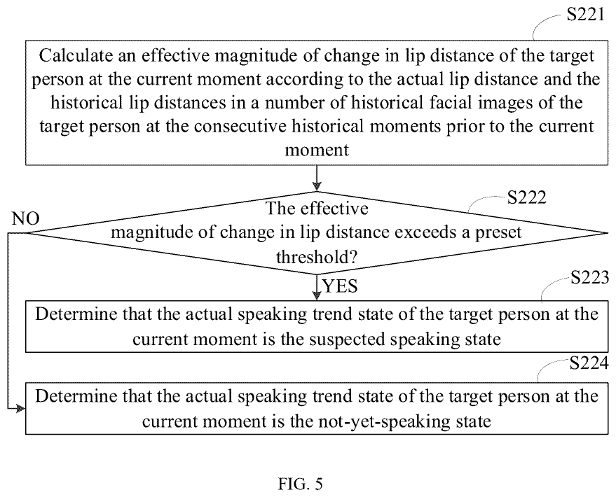

FIG. 5 is an exemplary flowchart of the steps included in step S220 in FIG. 2. In one embodiment, step S220 may include steps S221 to S224, so as to effectively determine the actual speaking trend state of the interacting person at the current moment during the process of speaking behavior change based on the detection of changes in lip distance across multiple consecutive frames of facial images.

Step S221: Calculate an effective magnitude of change in lip distance of the target person at the current moment according to the actual lip distance and the historical lip distances in a number of historical facial images of the target person at the consecutive historical moments prior to the current moment.

In one embodiment, the effective magnitude of change in lip distance is used to characterize the speaking behavior change trend of the target person at the current time within a first time period. Here, the upper time boundary of the first time period is the current moment, and the first time period is constituted by the current moment and a first preset number of historical moments continuously distributed prior to the current moment.

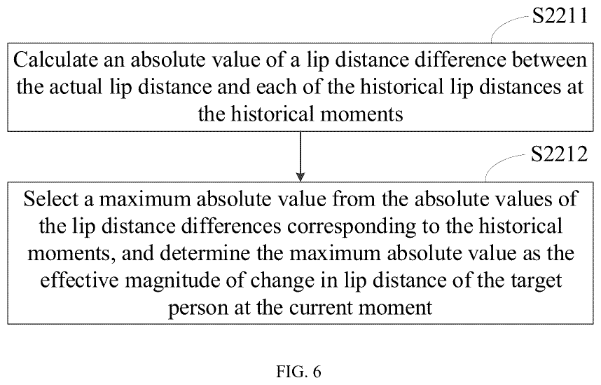

FIG. 6 is an exemplary flowchart of steps included in step S221 in FIG. 5. In one embodiment, step S221 may include steps S2211 to S2212 to simplify the process of measuring the speaking behavior change trend at any moment and improve the efficiency of measuring the speaking behavior change trend.

Step S2211: Calculate an absolute value of a lip distance difference between the actual lip distance and each of the historical lip distances at the historical moments.

In this embodiment, for each of the first preset number of historical lip distances, the absolute value of the lip distance difference between the actual lip distance and the historical lip distance can be obtained by calculating the absolute value of the lip distance difference between the actual lip distance and the historical lip distance.

Step S2212: Select a maximum absolute value from the absolute values of the lip distance differences corresponding to the historical moments, and determine the maximum absolute value as the effective magnitude of change in lip distance of the target person at the current moment.

Therefore, the robot control device can simplify the process of measuring the speech behavior change trend at any moment and improve the efficiency of measuring the speech behavior change trend by executing the above steps S2211 to S2212.

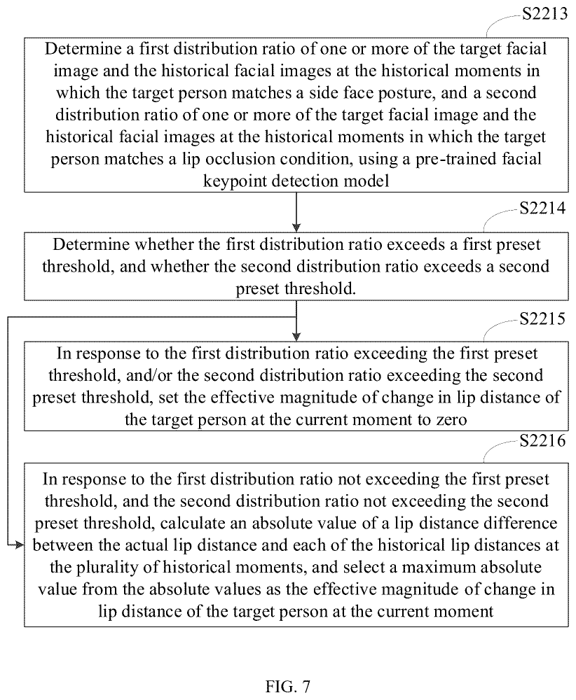

FIG. 7 is another exemplary flowchart of steps included in step S221 in FIG. 5. Due to interference from dynamic external environments, interacting person may experience lip occlusion or side-face posture within a certain period of time, resulting in the fact that the lip distances determined at different moments during this period using the facial keypoint detection model include partial data that cannot accurately represent the true lip movement of the interacting person. Therefore, when determining the speaking behavior change trend at any moment, it is necessary to perform anti-interference processing for the lip occlusion phenomenon and side-face posture phenomenon, so as to minimize false detection problems caused by non-user interactions due to dynamic external environments. In this case, the step S221 may include steps S2213 to S2216.

Step S2213: Determine a first distribution ratio of one or more of the target facial image and the historical facial images at the historical moments in which the target person matches a side face posture, and a second distribution ratio of one or more of the target facial image and the historical facial images at the historical moments in which the target person matches a lip occlusion condition, using a pre-trained facial keypoint detection model.

In this embodiment, each time the robot control device 10 invokes the facial keypoint detection model to detect the facial keypoints of any facial image, it will perform face regression prediction based on the detected face keypoint information to determine whether the face posture in the corresponding facial image is the side face posture. At the same time, it will also determine the actual lip area in the corresponding facial image based on the detected lip keypoint information, and then perform occlusion analysis on the image content in the actual lip area to determine whether there is lip area occlusion in the corresponding facial image. Specifically, when the face posture in the corresponding facial image satisfies the posture angle condition “the heading angle is less than 30°, the pitch angle is less than 20°, and the sum of the heading angle, the pitch angle and the roll angle is less than 60°,” the corresponding face posture is determined to be a side face posture; otherwise, the corresponding face posture is determined to be a front face posture. The robot control device 10 can perform mean calculation on the pixel position information of all lip keypoints in the facial image to obtain the central pixel position of the actual lip area in the facial image. Then, the robot control device 10 can determine the actual lip area size in the facial image based on the actual facial area size in the facial image according to the preset ratio of the lip area to the facial area (for example, the ratio of the lip area width to the facial area width is 0.7, and the ratio of the lip area height to the facial area height is 0.3), so as to delineate the actual lip area range in the facial image.

Therefore, when the robot control device 10 determines the actual lip distance of the target person at the current moment, as well as the historical lip distances of the target person at a first preset number of historical moments that are continuously distributed with respect to the current moment, it will perform face pose statistics and lip area occlusion count statistics on the corresponding facial images at the current and historical moments. Based on this, the robot control device 10 can obtain a first distribution ratio, which is the number of facial images exhibiting side face posture out of the total number of facial images (i.e., the first preset number plus one); and a second distribution ratio, which is the number of facial images exhibiting lip area occlusion out of the total number of facial images. These two distribution ratios are used to assess the respective impact levels of lip region occlusion and side face posture phenomena within the first time period. The larger the corresponding distribution ratio, the greater the impact of the lip occlusion or side face posture phenomenon.

In one embodiment, the robot control device 10 can construct a face posture queue and a lip occlusion queue for the target person at the storage 102. The robot control device 10 sequentially records, in chronological order, whether the face posture of the target person at different moments within a certain time period is in a side face state by means of the face posture queue, and sequentially records, in chronological order, whether the target person exhibits lip occlusion at different moments within a certain time period by means of the lip occlusion queue. The face posture queue, the lip occlusion queue, and the lip distance queue have the same queue length. Therefore, the robot control device 10 can write the actual face posture of the target person at the current moment to the tail of the face posture queue and delete the historical face posture recorded at the head of the face posture queue. In this case, the entire face posture queue can be directly used to calculate the first distribution ratio. The robot control device 10 can write the actual lip occlusion status of the target person at the current moment to the tail of the lip occlusion queue, and delete the historical lip occlusion status recorded at the head of the lip occlusion queue. In this case, the entire lip occlusion queue can be directly used to calculate the second distribution ratio.

Step S2214: Determine whether the first distribution ratio exceeds a first preset threshold, and whether the second distribution ratio exceeds a second preset threshold.

In one embodiment, the first preset threshold may be the same as the second preset threshold, for example, 70%. Alternatively, the first preset threshold may differ from the second preset threshold. For example, the first preset threshold is 75%, while the second preset threshold is 65%.

Step S2215: In response to the first distribution ratio exceeding the first preset threshold, and/or the second distribution ratio exceeding the second preset threshold, set the effective magnitude of change in lip distance of the target person at the current moment to zero.

In one embodiment, when it is detected that the first distribution ratio exceeds the first preset threshold, it indicates that the side face posture phenomenon caused by the external dynamic environment has seriously affected the reliability of the target person's lip distance during the first time period. To address false detections caused by non-user interactions in such external dynamic environments, the effective magnitude of change in lip distance of the target person at the current moment is set directly to zero. Similarly, when it is detected that the second distribution ratio exceeds the second preset threshold, it indicates that the lip occlusion phenomenon caused by the external dynamic environment has seriously affected the reliability of the target person's lip distance during the first time period. To address false detections caused by non-user interactions in such external dynamic environments, the effective magnitude of change in lip distance of the target person at the current moment is also set directly to zero.

Step S2216: In response to the first distribution ratio not exceeding the first preset threshold, and the second distribution ratio not exceeding the second preset threshold, calculate an absolute value of a lip distance difference between the actual lip distance and each of the historical lip distances at the plurality of historical moments, and select a maximum absolute value from the absolute values as the effective magnitude of change in lip distance of the target person at the current moment.

In one embodiment, when it is detected that the first distribution ratio does not exceed the first preset threshold, and the second distribution ratio does not exceed the second preset threshold, it indicates that the side face posture and lip occlusion phenomena caused by the external dynamic environment have little to no impact on the reliability of the target person's lip distance during the first time period. At this point, the same processing method as described in the above steps S2211 to S2212 may be applied to calculate the effective magnitude of change in lip distance of the target person at the current moment.

Accordingly, by executing the above steps S2213 to S2216, the robot control device can perform anti-interference processing for lip occlusion phenomena and side face posture phenomena when determining the speaking behavior change trend at any given moment, thereby minimizing false detection issues caused by non-user interactions resulting from external dynamic environments.

Step S222: Determine whether the effective magnitude of change in lip distance exceeds a preset threshold.

In one embodiment, when it is detected that the effective magnitude of change in lip distance of the target person at the current time exceeds the preset threshold, it indicates that the target person may still be speaking at the current moment, and the robot control device 10 correspondingly executes step S223. When it is detected that the effective magnitude of change in lip distance of the target person at the current moment does not exceed the preset threshold, it indicates that the target person can be considered as not speaking at the current moment, and the robot control device 10 correspondingly executes step S224.

Step S223: Determine that the actual speaking trend state of the target person at the current moment is the suspected speaking state.

Step S224: Determine that the actual speaking trend state of the target person at the current moment is the not-yet-speaking state.

Accordingly, by executing the above steps S221 to S224, the robot control device can effectively determine the actual speaking trend state of the interacting person at the current moment during the process of speaking behavior changes, based on lip distance changes across consecutive facial image frames.

Step S230: Perform state statistics on the actual speaking trend state and a number of historical speaking trend states of the target person at the consecutive historical moments prior to the current moment to obtain a real-time state distribution ratio of the suspected speaking state at the current moment.

In one embodiment, when the robot control device 10 determines that the actual speaking trend state of the target person at the current moment is a suspected speaking state, it selects, based on a second preset number (a positive integer greater than 1), the historical speaking trend states of the target person at multiple historical moments that are continuously distributed with respect to the current moment from the stored historical speaking trend states of the target person at multiple historical moments prior to the current moment. A voting mechanism is then employed to perform a suspected speaking state statistics on both the actual speaking trend state and the historical speaking trend states of the second preset number of historical moments, so as to determine the real-time state distribution ratio—i.e., the number of moments identified as suspected speaking states relative to the total number of moments (which is the second preset number plus one). The first preset number may be the same as or different from the second preset number.

In one embodiment, the robot control device 10 can construct a speaking trend state queue for the target person at the storage 102, and record the specific speaking trend state of the target person at different moments within a period of time in chronological order through the speaking trend state queue. Therefore, the robot control device 10 can write the actual speaking trend state of the target person at the current moment into the speaking trend state queue, and delete the first written historical speaking trend state in the speaking trend state queue. At this time, the speaking trend state queue can be directly used to calculate the real-time state distribution ratio of the suspected speaking state at the current moment. Here, the queue length of the speaking trend state queue is obtained by adding one to the second preset number.

Step S240: Determine whether the real-time state distribution ratio exceeds a preset state ratio threshold.

In one embodiment, when the target person's real-time state distribution ratio of the suspected speaking state at the current moment exceeds the preset state ratio threshold (for example, 30%), it indicates that the target person is continuously in the speaking state in a second time period, and the robot control device 10 will execute step S250 accordingly. When the target person's real-time state distribution ratio of the suspected speaking state at the current moment does not exceed the preset state ratio threshold, it indicates that the target person does not show a continuous speaking state in the second time period, and the robot control device 10 will execute step S260 accordingly. Here, the upper time boundary of the second time period is the current moment, and the second time period is constituted by the current moment and a second preset number of historical moments that are continuously distributed with respect to the current moment.

Step S250: Determine that the target person is speaking at the current moment.

Step S260: Determine that the target person is not speaking at the current moment.

Therefore, the robot control device can basically eliminate the negative impact of facial image keypoint disturbances on the speaking behavior detection operation and improve the speaking behavior missed/false detection problem by executing the above steps S210 to S260 based on the combination of detection of change in lip distance and voting mechanism of multiple consecutive frames of facial images, thereby improving the accuracy of speaking behavior detection, ensuring that the final output of speaking behavior detection results can meet the high accuracy requirements and effectively reflect the actual speaking status of the interacting person.

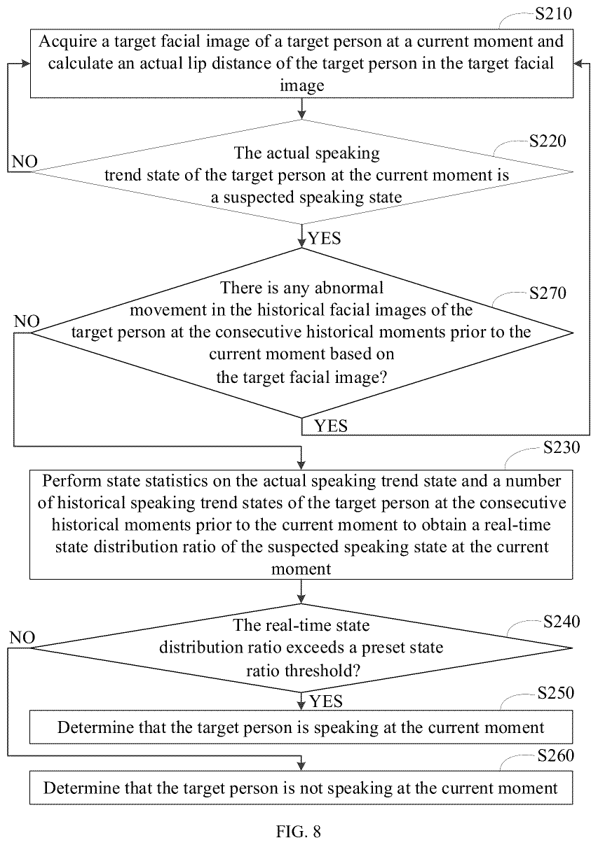

FIG. 8 is an exemplary flowchart of the method for detecting speaking behavior according to another embodiment. Due to interference from the external dynamic environment, the interacting person often exhibits unreasonable facial movements with excessively large displacement within a certain period of time. This results in drift of the facial keypoints detected by the facial keypoint detection model during that period, thereby causing some of the measured lip distance values at different moments within the period to fail to represent the actual lip movements of the interacting person. Therefore, before further confirming whether the target person is truly in a speaking state at the current moment, it is necessary to perform anti-interference processing for the unreasonable movement phenomenon, so as to avoid false detections caused by non-user interactions resulting from external dynamic environments. In this case, compared with the method shown in FIG. 2, the method for detecting speaking behavior illustrated in FIG. 8 may additionally include Step S270 between Step S220 and Step S230. Step S270 is executed when Step S220 determines that the actual speaking trend state of the target person at the current moment is a suspected speaking state.

Step S270: Determine whether there is any abnormal movement in the historical facial images of the target person at the consecutive historical moments prior to the current moment based on the target facial image.

In one embodiment, abnormal movements include abnormal vertical and horizontal movements, as well as abnormal forward and backward movements. When the robot control device 10 determines that the speaking trend state of the target person is a suspected speaking state at any given moment, it may use the facial image of the target person at that moment as the reference for movement abnormality detection. The robot control device 10 compares the face bounding box distribution of the target person's facial images at a first preset number of consecutive historical moments prior to that moment with the facial image at the current moment, in order to determine whether the facial region of the target person exhibits abnormal vertical and/or horizontal movements and/or abnormal forward and backward movements within a first time period that ends at the current moment as the upper time boundary.

When the robot control device 10 determines that there are abnormal movement phenomena in the historical facial images of the target person over multiple consecutive moments (i.e., the first preset number of historical moments) prior to the current moment, it indicates that the abnormal movements caused by the external dynamic environment have significantly affected the reliability of the lip distance within the first time period. To address the issue of false detections resulting from non-user interactions caused by the external environment, the target person at the current moment may be determined to be not speaking. The robot control device 10 will then return to Step S210, so that the speaking behavior detection can be performed on the facial image of the target person at the next time point (i.e., the new current moment).

When the robot control device 10 determines that there are no abnormal movement phenomena in the historical facial images of the target person over multiple consecutive moments prior to the current moment, it indicates that facial movements caused by the external dynamic environment have had little to no impact on the reliability of the lip distance within the first time period. In this case, the robot control device 10 will proceed to execute Steps S230 to S260 in order to further confirm whether the target person is truly in a speaking state at the current moment.

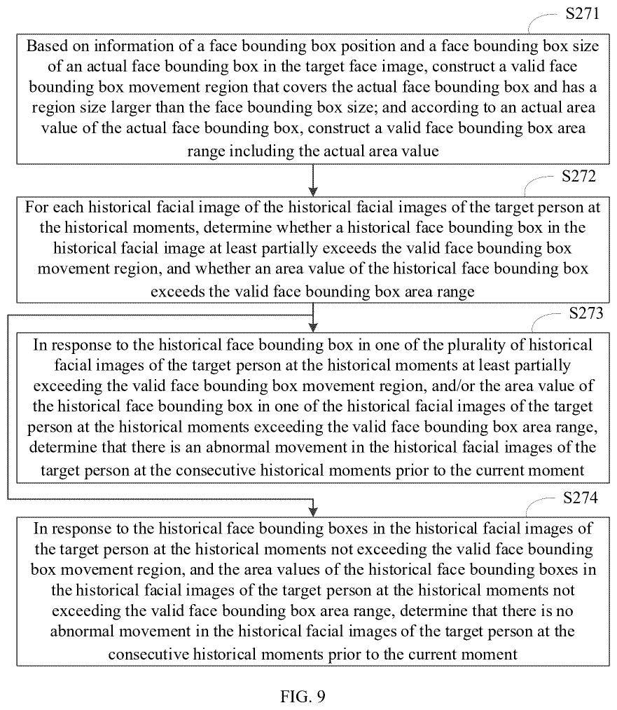

FIG. 9 is an exemplary flowchart illustrating the steps included in Step S270 of FIG. 8. In one embodiment, Step S270 may include steps S271 to S274, which are designed to effectively detect whether abnormal movement phenomena exist in the historical facial images of the target person over multiple consecutive moments prior to the current moment.

Step S271: Based on information of a face bounding box position and a face bounding box size of an actual face bounding box in the target face image, construct a valid face bounding box movement region that covers the actual face bounding box and has a region size larger than the face bounding box size; and according to an actual area value of the actual face bounding box, construct a valid face bounding box area range including the actual area value.

In one embodiment, the valid face bounding box movement region is used to detect whether the facial region of the target person exhibits abnormal vertical or horizontal movements within the first time period, while the valid face bounding box area range is used to detect whether the facial region exhibits abnormal forward or backward movements within the same period. Specifically, the valid face bounding box movement region can be obtained by taking the center of the actual rectangular face bounding box in the target face image as the scaling center point and proportionally enlarging the height and width of the actual face bounding box based on a preset scaling factor, which is greater than 1 (for example, 1.2). The lower bound of the valid face bounding box area range can be calculated by dividing the actual area value by a preset coefficient, and the upper bound can be calculated by multiplying the actual area value by the preset coefficient, where the preset coefficient is greater than 1 (for example, 1.44).

Step S272: For each historical facial image of the historical facial images of the target person at the historical moments, determine whether a historical face bounding box in the historical facial image at least partially exceeds the valid face bounding box movement region, and whether an area value of the historical face bounding box exceeds the valid face bounding box area range.

In one embodiment, for any given historical facial image, if at least one of the four corner points of the historical face bounding box lies outside the valid face bounding box movement region, it can be determined that the historical face bounding box of that image at least partially exceeds the valid face bounding box movement region.

Step S273: In response to the historical face bounding box in one of the plurality of historical facial images of the target person at the historical moments at least partially exceeding the valid face bounding box movement region, and/or the area value of the historical face bounding box in one of the historical facial images of the target person at the historical moments exceeding the valid face bounding box area range, determine that there is an abnormal movement in the historical facial images of the target person at the consecutive historical moments prior to the current moment.

If, among the historical facial images corresponding to the multiple historical moments, there exists any image in which the historical face bounding box at least partially exceeds the valid face bounding box movement region, it indicates that the target face has exhibited abnormal vertical or horizontal movement during the first time period corresponding to those historical moments. Similarly, if there exists any image in which the face bounding box area value exceeds the valid face bounding box area range, it indicates that the target face has exhibited abnormal forward or backward movement during the same first time period.

Step S274: In response to the historical face bounding boxes in the historical facial images of the target person at the historical moments not exceeding the valid face bounding box movement region, and the area values of the historical face bounding boxes in the historical facial images of the target person at the historical moments not exceeding the valid face bounding box area range, determine that there is no abnormal movement in the historical facial images of the target person at the consecutive historical moments prior to the current moment.

Accordingly, by executing the above steps S271 to S274, the robot control device can effectively detect whether abnormal movement phenomena exist in the historical facial images of the target person over multiple consecutive moments prior to the current moment.

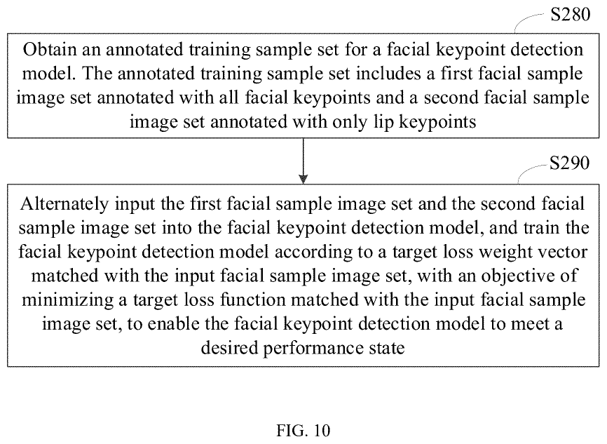

FIG. 10 is an exemplary flowchart of the method for detecting speaking behavior according to another embodiment. Compared with the methods shown in FIG. 2 or 8, the method illustrated in FIG. 10 may further include Step S280 and Step S290, in order to ensure that the trained facial keypoint detection model places greater emphasis on accurately locating lip keypoints during the facial keypoint detection process. This facilitates high-precision calculation of the lip distance using the trained facial keypoint detection model.

Step S280: Obtain an annotated training sample set for a facial keypoint detection model. The annotated training sample set includes a first facial sample image set annotated with all facial keypoints and a second facial sample image set annotated with only lip keypoints.

It should be noted that a keypoint detection model trained using facial sample images annotated only with lip keypoints tends to exhibit unstable lip keypoint predictions when processing facial images affected by external factors. Additionally, a keypoint detection model trained using facial sample images annotated with all facial keypoints primarily focuses on the global facial correlation, making it less effective in achieving finer localization of lip keypoints. Therefore, to ensure that the trained facial keypoint detection model places greater emphasis on accurately locating lip keypoints during the facial keypoint detection process, an annotated training sample set can be constructed based on a first facial sample image set annotated with all facial keypoints (e.g., the 98 facial keypoints shown in FIG. 4) and a second facial sample image set annotated only with lip keypoints (e.g., facial keypoints 76-95 within the rectangular box in FIG. 4). The first facial sample image set includes multiple facial sample images, each annotated with 98 facial keypoints, while the second facial sample image set includes multiple facial sample images, each annotated with 20 lip keypoints. In one embodiment, the model architecture of the facial keypoint detection model may be implemented using the lightweight keypoint prediction network ShuffleNetV2.

Step S290: Alternately input the first facial sample image set and the second facial sample image set into the facial keypoint detection model, and train the facial keypoint detection model according to a target loss weight vector matched with the input facial sample image set, with an objective of minimizing a target loss function matched with the input facial sample image set, to enable the facial keypoint detection model to meet a desired performance state.

In one embodiment, different facial sample image sets correspond to different loss functions. The loss function corresponding to the first facial sample image set may be, but is not limited to, at least one of the following commonly used loss functions: mean squared error (MSE) loss function, L2 loss function, L1 loss function, Smooth L1 loss function, Huber loss function, Kullback-Leibler (KL) divergence loss function, cross-entropy loss function, softmax loss function, and Focal Loss function. The loss function corresponding to the second facial sample image set may be the Wing Loss function. Different facial sample image sets correspond to different loss weight vectors. The first loss weight vector, which matches the first facial sample image set, and the second loss weight vector, which matches the second facial sample image set, share the same vector dimension (e.g., 98). Each loss weight vector includes the individual loss weight values of the 98 facial keypoints during the model training process. The loss weight values of inner lip keypoints in the first loss weight vector is greater than loss weight values of other face keypoints other than the inner lip keypoints. In the first loss weight vector, the loss weight values of facial keypoints other than the inner lip keypoints remain consistent. For example, the first loss weight vector can be represented as [1,1,1, . . . 1,1,5,5,5,1,5,5,5,1,1]₉₈, where facial keypoints 89-91 and 93-95 represent the six inner lip keypoints. Each of these six inner lip keypoints is assigned a loss weight value of 5, while each of the remaining 92 facial keypoints is assigned a loss weight value of 1. The loss weight values of other face keypoints other than lip keypoints in the second loss weight vector are zero. The loss weight values of the inner lip keypoints in the second loss weight vector are greater than loss weight values of other lip keypoints other than the inner lip keypoints. For example, the second loss weight vector can be represented as [0,0,0, . . . 1,1,5,5,5,1,5,5,5,0,0]₉₈, where facial keypoints 76-95 are the lip keypoints; keypoints 89-91 and 93-95 are the six inner lip keypoints, and keypoints 76-88, 92, and 96-97 are the remaining 14 lip keypoints. Each of the six inner lip keypoints is assigned a loss weight value of 5, each of the 14 other lip keypoints is assigned a loss weight value of 1, and each of the remaining 78 facial keypoints is assigned a loss weight value of 0.

Accordingly, by executing the above Steps S280 and S290, the robot control device can ensure that the trained facial keypoint detection model places greater emphasis on accurately locating lip keypoints during the facial keypoint detection process, thereby facilitating high-precision calculation of lip distance using the trained model.

It should be understood that sequence numbers of the foregoing processes do not mean an execution sequence in the above-mentioned embodiments. The execution sequence of the processes should be determined according to functions and internal logic of the processes, and should not be construed as any limitation on the implementation processes of the above-mentioned embodiments.

Another aspect of the present disclosure is directed to a non-transitory computer-readable medium storing instructions which, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer-readable medium may be the storage device or the memory module having the computer instructions stored thereon, as disclosed. In one embodiment, the computer-readable medium may be a disc or a flash drive having the computer instructions stored thereon.

It should be understood that the disclosed device and method can also be implemented in other manners. The device embodiments described above are merely illustrative. For example, the flowcharts and block diagrams in the accompanying drawings illustrate the architecture, functionality and operation of possible implementations of the device, method and computer program product according to embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

In addition, functional modules in the embodiments of the present disclosure may be integrated into one independent part, or each of the modules may be independent, or two or more modules may be integrated into one independent part. in addition, functional modules in the embodiments of the present disclosure may be integrated into one independent part, or each of the modules may exist alone, or two or more modules may be integrated into one independent part. When the functions are implemented in the form of a software functional unit and sold or used as an independent product, the functions may be stored in a computer-readable storage medium. Based on such an understanding, the technical solutions in the present disclosure essentially, or the part contributing to the prior art, or some of the technical solutions may be implemented in a form of a software product. The computer software product is stored in a storage medium and includes several instructions for instructing a computer device (which may be a personal computer, a server, a network device, or the like) to perform all or some of the steps of the methods described in the embodiments of the present disclosure. The foregoing storage medium includes: any medium that can store program code, such as a USB flash drive, a removable hard disk, a read-only memory (ROM), a random access memory (RAM), a magnetic disk, or an optical disc.

A person skilled in the art can clearly understand that for the purpose of convenient and brief description, for specific working processes of the device, modules and units described above, reference may be made to corresponding processes in the embodiments of the foregoing method, which are not repeated herein.

In the embodiments above, the description of each embodiment has its own emphasis. For parts that are not detailed or described in one embodiment, reference may be made to related descriptions of other embodiments.

A person having ordinary skill in the art may clearly understand that, for the convenience and simplicity of description, the division of the above-mentioned functional units and modules is merely an example for illustration. In actual applications, the above-mentioned functions may be allocated to be performed by different functional units according to requirements, that is, the internal structure of the device may be divided into different functional units or modules to complete all or part of the above-mentioned functions. The functional units and modules in the embodiments may be integrated in one processing unit, or each unit may exist alone physically, or two or more units may be integrated in one unit. The above-mentioned integrated unit may be implemented in the form of hardware or in the form of software functional unit. In addition, the specific name of each functional unit and module is merely for the convenience of distinguishing each other and are not intended to limit the scope of protection of the present disclosure. For the specific operation process of the units and modules in the above-mentioned system, reference may be made to the corresponding processes in the above-mentioned method embodiments, and are not described herein.

A person having ordinary skill in the art may clearly understand that, the exemplificative units and steps described in the embodiments disclosed herein may be implemented through electronic hardware or a combination of computer software and electronic hardware. Whether these functions are implemented through hardware or software depends on the specific application and design constraints of the technical schemes. Those ordinary skilled in the art may implement the described functions in different manners for each particular application, while such implementation should not be considered as beyond the scope of the present disclosure.

In the embodiments provided by the present disclosure, it should be understood that the disclosed apparatus (device)/terminal device and method may be implemented in other manners. For example, the above-mentioned apparatus (device)/terminal device embodiment is merely exemplary. For example, the division of modules or units is merely a logical functional division, and other division manner may be used in actual implementations, that is, multiple units or components may be combined or be integrated into another system, or some of the features may be ignored or not performed. In addition, the shown or discussed mutual coupling may be direct coupling or communication connection, and may also be indirect coupling or communication connection through some interfaces, devices or units, and may also be electrical, mechanical or other forms.

The units described as separate parts may or may not be physically separate, and parts displayed as units may or may not be physical units, may be located in one position, or may be distributed on a plurality of network units. Some or all of the modules may be selected according to actual requirements to achieve the objectives of the solutions of the embodiments.

The functional units and modules in the embodiments may be integrated in one processing unit, or each unit may exist alone physically, or two or more units may be integrated in one unit. The above-mentioned integrated unit may be implemented in the form of hardware or in the form of software functional unit.

When the integrated module/unit is implemented in the form of a software functional unit and is sold or used as an independent product, the integrated module/unit may be stored in a non-transitory computer-readable storage medium. Based on this understanding, all or part of the processes in the method for implementing the above-mentioned embodiments of the present disclosure may also be implemented by instructing relevant hardware through a computer program. The computer program may be stored in a non-transitory computer-readable storage medium, which may implement the steps of each of the above-mentioned method embodiments when executed by a processor. In which, the computer program includes computer program codes which may be the form of source codes, object codes, executable files, certain intermediate, and the like. The computer-readable medium may include any primitive or device capable of carrying the computer program codes, a recording medium, a USB flash drive, a portable hard disk, a magnetic disk, an optical disk, a computer memory, a read-only memory (ROM), a random-access memory (RAM), electric carrier signals, telecommunication signals and software distribution media. It should be noted that the content contained in the computer readable medium may be appropriately increased or decreased according to the requirements of legislation and patent practice in the jurisdiction. For example, in some jurisdictions, according to the legislation and patent practice, a computer readable medium does not include electric carrier signals and telecommunication signals.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A computer-implemented method for detecting speaking behavior, the method comprising:
a) acquiring a target facial image of a target person at a current moment and calculating an actual lip distance of the target person in the target facial image;
b) determining whether an actual speaking trend state of the target person at the current moment is a suspected speaking state according to the actual lip distance and a plurality of historical lip distances in a plurality of historical facial images of the target person at a plurality of consecutive historical moments prior to the current moment;
c) in response to the actual speaking trend state being the suspected speaking state, performing state statistics on the actual speaking trend state and a plurality of historical speaking trend states of the target person at the plurality of consecutive historical moments prior to the current moment to obtain a real-time state distribution ratio of the suspected speaking state at the current moment;
d) determining whether the real-time state distribution ratio exceeds a preset state ratio threshold; and
e) in response to the real-time state distribution ratio exceeding the preset state ratio threshold, determining that the target person is speaking at the current moment.

2. The method of claim 1, wherein calculating the actual lip distance of the target person in the target facial image comprising:
performing facial keypoint detection on the target facial image using a pre-trained facial keypoint detection model to obtain lip keypoint information in the target facial image;
calculating a plurality of upper and lower inner lip distances corresponding to a plurality of groups of inner lip keypoints in the target facial image according to the lip keypoint information, wherein each of the plurality of groups of inner lip keypoints comprises an upper inner lip keypoint and a lower inner lip keypoint; and
performing an averaging operation on the upper and lower inner lip distances corresponding to the plurality of groups of inner lip keypoints to obtain the actual lip distance of the target person in the target facial image.

3. The method of claim 1, wherein determining whether the actual speaking trend state of the target person at the current moment is the suspected speaking state comprises:
calculating an effective magnitude of change in lip distance of the target person at the current moment according to the actual lip distance and the plurality of historical lip distances in a plurality of historical facial images of the target person at the plurality of consecutive historical moments prior to the current moment;
determining whether the effective magnitude of change in lip distance exceeds a preset threshold; and
in response to the effective magnitude of change in lip distance exceeding the preset threshold, determining that the actual speaking trend state of the target person at the current moment is the suspected speaking state.

4. The method of claim 3, wherein calculating the effective magnitude of change in lip distance of the target person at the current moment comprises:
calculating an absolute value of a lip distance difference between the actual lip distance and each of the historical lip distances at the plurality of historical moments; and
selecting a maximum absolute value from the absolute values of the lip distance differences corresponding to the plurality of historical moments, and determining the maximum absolute value as the effective magnitude of change in lip distance of the target person at the current moment.

5. The method of claim 3, wherein calculating the effective magnitude of change in lip distance of the target person at the current moment comprises:
determining a first distribution ratio of one or more of the target facial image and the historical facial images at the plurality of historical moments in which the target person matches a side face posture, and a second distribution ratio of one or more of the target facial image and the historical facial images at the plurality of historical moments in which the target person matches a lip occlusion condition, using a pre-trained facial keypoint detection model;
determining whether the first distribution ratio exceeds a first preset threshold, and whether the second distribution ratio exceeds a second preset threshold;
in response to the first distribution ratio exceeding the first preset threshold, and/or the second distribution ratio exceeding the second preset threshold, setting the effective magnitude of change in lip distance of the target person at the current moment to zero; and
in response to the first distribution ratio not exceeding the first preset threshold, and the second distribution ratio not exceeding the second preset threshold, calculating an absolute value of a lip distance difference between the actual lip distance and each of the historical lip distances at the plurality of historical moments, and selecting a maximum absolute value from the absolute values as the effective magnitude of change in lip distance of the target person at the current moment.

6. The method of claim 1, further comprising, before performing state statistics on the actual speaking trend state and the plurality of historical speaking trend states of the target person at the plurality of consecutive historical moments prior to the current moment,
in response to the actual speaking trend state being the suspected speaking state, determining whether there is any abnormal movement in the historical facial images of the target person at the plurality of consecutive historical moments prior to the current moment based on the target facial image; and
in response to there being no abnormal movement in the historical facial images of the target person at the plurality of consecutive historical moments prior to the current moment, returning to c).

7. The method of claim 6, wherein determining whether there is any abnormal movement in the historical facial images of the target person at the plurality of consecutive historical moments prior to the current moment based on the target facial image comprises:
based on information of a face bounding box position and a face bounding box size of an actual face bounding box in the target face image, constructing a valid face bounding box movement region that covers the actual face bounding box and has a region size larger than the face bounding box size; and according to an actual area value of the actual face bounding box, constructing a valid face bounding box area range including the actual area value;
for each historical facial image of the plurality of historical facial images of the target person at the plurality of historical moments, determining whether a historical face bounding box in the historical facial image at least partially exceeds the valid face bounding box movement region, and whether an area value of the historical face bounding box exceeds the valid face bounding box area range;
in response to the historical face bounding box in one of the plurality of historical facial images of the target person at the plurality of historical moments at l east partially exceeding the valid face bounding box movement region, and/or the area value of the historical face bounding box in one of the plurality of historical facial images of the target person at the plurality of historical moments exceeding the valid face bounding box area range, determining that there is an abnormal movement in the historical facial images of the target person at the plurality of consecutive historical moments prior to the current moment; and
in response to the historical face bounding boxes in the plurality of historical facial images of the target person at the plurality of historical moments not exceeding the valid face bounding box movement region, and the area values of the historical face bounding boxes in the plurality of historical facial images of the target person at the plurality of historical moments not exceeding the valid face bounding box area range, determining that there is no abnormal movement in the historical facial images of the target person at the plurality of consecutive historical moments prior to the current moment.

8. The method of claim 1, further comprising:
obtaining an annotated training sample set for a facial keypoint detection model, wherein the annotated training sample set comprises a first facial sample image set annotated with all facial keypoints and a second facial sample image set annotated with only lip keypoints; and
alternately inputting the first facial sample image set and the second facial sample image set into the facial keypoint detection model, and training the facial keypoint detection model according to a target loss weight vector matched with the input facial sample image set, with an objective of minimizing a target loss function matched with the input facial sample image set, to enable the facial keypoint detection model to meet a desired performance state; wherein a first loss weight vector matching the first face sample image set and a second loss weight vector matching the second face sample image set maintain a same vector dimension; loss weight values of inner lip keypoints in the first loss weight vector is greater than loss weight values of other face keypoints other than the inner lip keypoints; loss weight values of other facial keypoints other than lip keypoints in the second loss weight vector are zero; loss weight values of the inner lip keypoints in the second loss weight vector are greater than loss weight values of other lip keypoints other than the inner lip keypoints.

9. A robot control device comprising:
one or more processors; and
a memory coupled to the one or more processors, the memory storing programs that, when executed by the one or more processors, cause performance of operations comprising:
a) acquiring a target facial image of a target person at a current moment and calculating an actual lip distance of the target person in the target facial image;
b) determining whether an actual speaking trend state of the target person at the current moment is a suspected speaking state according to the actual lip distance and a plurality of historical lip distances in a plurality of historical facial images of the target person at a plurality of consecutive historical moments prior to the current moment;
c) in response to the actual speaking trend state being the suspected speaking state, performing state statistics on the actual speaking trend state and a plurality of historical speaking trend states of the target person at the plurality of consecutive historical moments prior to the current moment to obtain a real-time state distribution ratio of the suspected speaking state at the current moment;
d) determining whether the real-time state distribution ratio exceeds a preset state ratio threshold; and
e) in response to the real-time state distribution ratio exceeding the preset state ratio threshold, determining that the target person is speaking at the current moment.

10. The robot control device of claim 9, wherein calculating the actual lip distance of the target person in the target facial image comprises:
performing facial keypoint detection on the target facial image using a pre-trained facial keypoint detection model to obtain lip keypoint information in the target facial image;
calculating a plurality of upper and lower inner lip distances corresponding to a plurality of groups of inner lip keypoints in the target facial image according to the lip keypoint information, wherein each of the plurality of groups of inner lip keypoints comprises an upper inner lip keypoint and a lower inner lip keypoint; and
performing an averaging operation on the upper and lower inner lip distances corresponding to the plurality of groups of inner lip keypoints to obtain the actual lip distance of the target person in the target facial image.

11. The robot control device of claim 9, wherein determining whether the actual speaking trend state of the target person at the current moment is the suspected speaking state comprises:
calculating an effective magnitude of change in lip distance of the target person at the current moment according to the actual lip distance and the plurality of historical lip distances in a plurality of historical facial images of the target person at the plurality of consecutive historical moments prior to the current moment;
determining whether the effective magnitude of change in lip distance exceeds a preset threshold; and
in response to the effective magnitude of change in lip distance exceeding the preset threshold, determining that the actual speaking trend state of the target person at the current moment is the suspected speaking state.

12. The robot control device of claim 11, wherein calculating the effective magnitude of change in lip distance of the target person at the current moment comprises:
calculating an absolute value of a lip distance difference between the actual lip distance and each of the historical lip distances at the plurality of historical moments; and
selecting a maximum absolute value from the absolute values of the lip distance differences corresponding to the plurality of historical moments, and determining the maximum absolute value as the effective magnitude of change in lip distance of the target person at the current moment.

13. The robot control device of claim 11, wherein calculating the effective magnitude of change in lip distance of the target person at the current moment comprises:
determining a first distribution ratio of one or more of the target facial image and the historical facial images at the plurality of historical moments in which the target person matches a side face posture, and a second distribution ratio of one or more of the target facial image and the historical facial images at the plurality of historical moments in which the target person matches a lip occlusion condition, using a pre-trained facial keypoint detection model;
determining whether the first distribution ratio exceeds a first preset threshold, and whether the second distribution ratio exceeds a second preset threshold;
in response to the first distribution ratio exceeding the first preset threshold, and/or the second distribution ratio exceeding the second preset threshold, setting the effective magnitude of change in lip distance of the target person at the current moment to zero; and
in response to the first distribution ratio not exceeding the first preset threshold, and the second distribution ratio not exceeding the second preset threshold, calculating an absolute value of a lip distance difference between the actual lip distance and each of the historical lip distances at the plurality of historical moments, and selecting a maximum absolute value from the absolute values as the effective magnitude of change in lip distance of the target person at the current moment.

14. The robot control device of claim 9, wherein the operations further comprise, before performing state statistics on the actual speaking trend state and the plurality of historical speaking trend states of the target person at the plurality of consecutive historical moments prior to the current moment,
in response to the actual speaking trend state being the suspected speaking state, determining whether there is any abnormal movement in the historical facial images of the target person at the plurality of consecutive historical moments prior to the current moment based on the target facial image; and
in response to there being no abnormal movement in the historical facial images of the target person at the plurality of consecutive historical moments prior to the current moment, returning to c).

15. The robot control device of claim 14, wherein determining whether there is any abnormal movement in the historical facial images of the target person at the plurality of consecutive historical moments prior to the current moment based on the target facial image comprises:
based on information of a face bounding box position and a face bounding box size of an actual face bounding box in the target face image, constructing a valid face bounding box movement region that covers the actual face bounding box and has a region size larger than the face bounding box size; and according to an actual area value of the actual face bounding box, constructing a valid face bounding box area range including the actual area value;
for each historical facial image of the plurality of historical facial images of the target person at the plurality of historical moments, determining whether a historical face bounding box in the historical facial image at least partially exceeds the valid face bounding box movement region, and whether an area value of the historical face bounding box exceeds the valid face bounding box area range;
in response to the historical face bounding box in one of the plurality of historical facial images of the target person at the plurality of historical moments at least partially exceeding the valid face bounding box movement region, and/or the area value of the historical face bounding box in one of the plurality of historical facial images of the target person at the plurality of historical moments exceeding the valid face bounding box area range, determining that there is an abnormal movement in the historical facial images of the target person at the plurality of consecutive historical moments prior to the current moment; and
in response to the historical face bounding boxes in the plurality of historical facial images of the target person at the plurality of historical moments not exceeding the valid face bounding box movement region, and the area values of the historical face bounding boxes in the plurality of historical facial images of the target person at the plurality of historical moments not exceeding the valid face bounding box area range, determining that there is no abnormal movement in the historical facial images of the target person at the plurality of consecutive historical moments prior to the current moment.

16. The robot control device of claim 9, wherein the operations further comprise:
obtaining an annotated training sample set for a facial keypoint detection model, wherein the annotated training sample set comprises a first facial sample image set annotated with all facial keypoints and a second facial sample image set annotated with only lip keypoints; and
alternately inputting the first facial sample image set and the second facial sample image set into the facial keypoint detection model, and training the facial keypoint detection model according to a target loss weight vector matched with the input facial sample image set, with an objective of minimizing a target loss function matched with the input facial sample image set, to enable the facial keypoint detection model to meet a desired performance state; wherein a first loss weight vector matching the first face sample image set and a second loss weight vector matching the second face sample image set maintain a same vector dimension; loss weight values of inner lip keypoints in the first loss weight vector is greater than loss weight values of other face keypoints other than the inner lip keypoints; loss weight values of other facial keypoints other than lip keypoints in the second loss weight vector are zero; loss weight values of the inner lip keypoints in the second loss weight vector are greater than loss weight values of other lip keypoints other than the inner lip keypoints.

17. A non-transitory computer-readable storage medium storing instructions that, when executed by at least one processor of a robot control device, cause the at least one processor to perform a method for detecting speaking behavior, the method comprising:
a) acquiring a target facial image of a target person at a current moment and calculating an actual lip distance of the target person in the target facial image;
b) determining whether an actual speaking trend state of the target person at the current moment is a suspected speaking state according to the actual lip distance and a plurality of historical lip distances in a plurality of historical facial images of the target person at a plurality of consecutive historical moments prior to the current moment;
c) in response to the actual speaking trend state being the suspected speaking state, performing state statistics on the actual speaking trend state and a plurality of historical speaking trend states of the target person at the plurality of consecutive historical moments prior to the current moment to obtain a real-time state distribution ratio of the suspected speaking state at the current moment;
d) determining whether the real-time state distribution ratio exceeds a preset state ratio threshold; and
e) in response to the real-time state distribution ratio exceeding the preset state ratio threshold, determining that the target person is speaking at the current moment.

18. The non-transitory computer-readable storage medium of claim 17, wherein calculating the actual lip distance of the target person in the target facial image comprising:
performing facial keypoint detection on the target facial image using a pre-trained facial keypoint detection model to obtain lip keypoint information in the target facial image;
calculating a plurality of upper and lower inner lip distances corresponding to a plurality of groups of inner lip keypoints in the target facial image according to the lip keypoint information, wherein each of the plurality of groups of inner lip keypoints comprises an upper inner lip keypoint and a lower inner lip keypoint; and
performing an averaging operation on the upper and lower inner lip distances corresponding to the plurality of groups of inner lip keypoints to obtain the actual lip distance of the target person in the target facial image.

19. The non-transitory computer-readable storage medium of claim 17, wherein determining whether the actual speaking trend state of the target person at the current moment is the suspected speaking state comprises:
calculating an effective magnitude of change in lip distance of the target person at the current moment according to the actual lip distance and the plurality of historical lip distances in a plurality of historical facial images of the target person at the plurality of consecutive historical moments prior to the current moment;
determining whether the effective magnitude of change in lip distance exceeds a preset threshold; and
in response to the effective magnitude of change in lip distance exceeding the preset threshold, determining that the actual speaking trend state of the target person at the current moment is the suspected speaking state.

20. The non-transitory computer-readable storage medium of claim 19, wherein calculating the effective magnitude of change in lip distance of the target person at the current moment comprises:
calculating an absolute value of a lip distance difference between the actual lip distance and each of the historical lip distances at the plurality of historical moments; and
selecting a maximum absolute value from the absolute values of the lip distance differences corresponding to the plurality of historical moments, and determining the maximum absolute value as the effective magnitude of change in lip distance of the target person at the current moment.
